(19) United States
(12) Patent Application Publication
(10) Pub. No.: US 2019/0285977 A1
(43) Pub. Date: Sep. 19, 2019

(54) LASER PROJECTION APPARATUS

(71) Applicant: QINGDAO HISENSE LASER DISPLAY CO., LTD., Qingdao (CN)

(72) Inventors: Youliang TIAN, Qingdao (CN); Wei LI, Qingdao (CN); Zinan ZHOU, Qingdao (CN); Peng SUN, Qingdao (CN)

(73) Assignee: QINGDAO HISENSE LASER DISPLAY CO., LTD.

(21) Appl. No.: 16/025,728

(22) Filed: Jul. 2, 2018

(30) Foreign Application Priority Data
Mar. 16, 2018 (CN) 201810218721.8
Mar. 16, 2018 (CN) 201810218722.2
Mar. 16, 2018 (CN) 201810219611.3
Mar. 16, 2018 (CN) 201810219614.7
Mar. 16, 2018 (CN) 201820361401.3

(51) Int. Cl. G03B 21/20; G02B 27/10; G02B 27/14

(52) U.S. Cl. CPC G03B 21/2033; G03B 21/2013; G02B 27/141; G03B 21/208; G02B 27/1006; G03B 21/2066

(57) ABSTRACT

A laser projection apparatus includes a first laser array, a second laser array, a third laser array, a fourth laser array, a first light-combining component, a second light-combining component and a beam-combining component. The first laser array is configured to emit first laser beams of a first color. The second laser array is configured to emit second laser beams of the first color. The third laser array is configured to emit third laser beams of a second color. The fourth laser array is configured to emit fourth laser beams of a third color. The first color, the second color and the third color are different from each other, and each of the first color, the second color and the third color is one of red, green and blue.

### CROSS-REFERENCE TO RELATED APPLICATION

This application claims priority under 35 U.S.C. § 119 to Chinese Patent Application No. 201810219614.7, filed on Mar. 16, 2018, titled “A TRICHROMATIC LASER SOURCE AND LASER PROJECTION APPARATUS”, Chinese Patent Application No. 201810218722.2, filed on Mar. 16, 2018, titled “A TRICHROMATIC LASER SOURCE AND LASER PROJECTION APPARATUS”, Chinese Patent Application No. 201810218721.8, filed on Mar. 16, 2018, titled “A TRICHROMATIC LASER SOURCE AND LASER PROJECTION APPARATUS”, Chinese Patent Application No. 201810219611.3, filed on Mar. 16, 2018, titled “A TRICHROMATIC LASER SOURCE AND LASER PROJECTION APPARATUS”, Chinese Patent Application No. 201820361401.3, filed on Mar. 16, 2018, titled “A TRICHROMATIC LASER SOURCE”, which are incorporated herein by reference in their entirety.

### TECHNICAL FIELD

The present disclosure relates to the field of laser source technologies, and more particularly to a laser projection apparatus.

### BACKGROUND

A laser source of a laser projection apparatus emits a blue laser beam. The blue laser beam is incident onto a fluorescent wheel to excite green phosphors and yellow phosphors in the fluorescent wheel to generate green light and yellow light, respectively. Then, the yellow light is filtered to get red light.

### SUMMARY

In one aspect, a laser projection apparatus includes first through fourth laser arrays, first and second light-combining components, and a beam-combining component. The first laser array is configured to emit first laser beams of a first color. The second laser array is configured to emit second laser beams of the first color. The third laser array is configured to emit third laser beams of a second color. The fourth laser array is configured to emit fourth laser beams of a third color. The first light-combining component is configured to make the first laser beams and the second laser beams advance along a first direction. The second light-combining component is configured to make the third laser beams and the fourth laser beams advance along a second direction. The beam-combining component is located on an optical path of the first laser beams and the second laser beams emitted from the first light-combining component, located on an optical path of the third laser beams and the fourth laser beams emitted from the second light-combining component, and configured to make the first laser beams and the second laser beams emitted from the first light-combining component and the third laser beams and the fourth laser beams emitted from the second light-combining component advance along a third direction. The first color, the second color and the third color are different from each other, and each of the first color, the second color and the third color is one of red, green and blue.

### BRIEF DESCRIPTION OF THE DRAWINGS

In order to describe technical solutions in embodiments of the present disclosure, the accompanying drawings to be used in the description of embodiments will be introduced briefly. Obviously, the accompanying drawings to be described below are merely some embodiments of the present disclosure, and a person of ordinary skill in the art can obtain other drawings according to those drawings without paying any creative effort.

FIG. 1 is a schematic diagram of a laser projection apparatus in the related art;

FIG. 2 is a schematic diagram of a laser projection apparatus including a first light-combining component and a second light-combining component according to some embodiments of the present disclosure;

FIG. 3 is a schematic diagram of a first light-combining component according to some embodiments of the present disclosure;

FIG. 4 is a schematic diagram of a second light-combining component according to some embodiments of the present disclosure;

FIG. 5 is a schematic diagram of another laser projection apparatus including a first light-combining component and a second light-combining component according to some embodiments of the present disclosure;

FIG. 6 is a schematic diagram of further another laser projection apparatus including a first light-combining component and a second light-combining component according to some embodiments of the present disclosure;

FIG. 7 is a schematic diagram of yet another laser projection apparatus including a first light-combining component and a second light-combining component according to some embodiments of the present disclosure;

FIG. 8 is a schematic diagram of a laser projection apparatus including a first light-combining component, a second light-combining component and a third light-combining component according to some embodiments of the present disclosure;

FIG. 9 is a schematic diagram of a third light-combining component according to some embodiments of the present disclosure;

FIG. 10 is a schematic diagram of another laser projection apparatus including a first light-combining component, a second light-combining component and a third light-combining component according to some embodiments of the present disclosure;

FIG. 11 is a schematic diagram of further another laser projection apparatus including a first light-combining component, a second light-combining component and a third light-combining component according to some embodiments of the present disclosure;

FIG. 12 is a schematic diagram of yet another laser projection apparatus including a first light-combining component, a second light-combining component and a third light-combining component according to some embodiments of the present disclosure;

FIG. 13 is a schematic diagram of yet still another laser projection apparatus including a first light-combining component, a second light-combining component and a third light-combining component according to some embodiments of the present disclosure;

FIG. 14 is a schematic diagram of another second light-combining component according to some embodiments of the present disclosure;

FIG. 15 is a schematic diagram of another third light-combining component according to some embodiments of the present disclosure;

FIG. 16 is a schematic diagram of yet still another laser projection apparatus including a first light-combining component, a second light-combining component and a third light-combining component according to some embodiments of the present disclosure;

FIG. 17 is a schematic diagram of yet still further another laser projection apparatus including a first light-combining component, a second light-combining component and a third light-combining component according to some embodiments of the present disclosure;

FIG. 18 is a schematic diagram of yet still further another laser projection apparatus including a first light-combining component, a second light-combining component and a third light-combining component according to some embodiments of the present disclosure;

FIG. 19 is a cross section diagram of a fly-eye lens according to some embodiments of the present disclosure; and

FIG. 20 is a schematic diagram of another laser projection apparatus according to some embodiments of the present disclosure.

### DETAILED DESCRIPTION

Embodiments of the present disclosure will be described in detail with reference to the accompanying drawings to make the objectives, technical solutions and the advantages of the present disclosure more clearly. Obviously, the described embodiments are merely some but not all of embodiments of the present disclosure. All other embodiments made on the basis of the embodiments of the present disclosure by a person of ordinary skill in the art without paying any creative effort shall be included in the protection scope of the present disclosure.

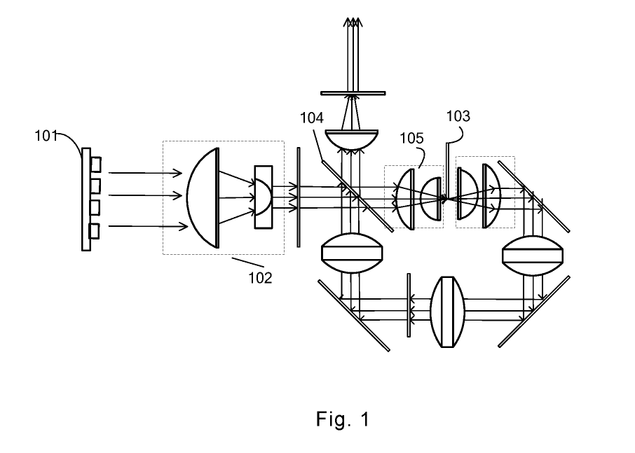

In the related art, as shown in FIG. 1, a laser array 101 emits blue laser beams, which reach a dichroic mirror 104 after passing through a beam-shrinking system 102, and then reach a focusing and collimating lens group 105 after passing through the dichroic mirror 104.The beams emitted from the focusing and collimating lens group 105 reach a fluorescent wheel 103 to excite the fluorescent wheel 103 to emit a fluorescence. Here the fluorescent wheel 103 is, for example, a reflective fluorescent wheel (including a fluorescent region and a transmission region). The fluorescent region of the fluorescent wheel 103 is excited by the laser beams to emit the fluorescence, and then the fluorescence is reflected by the fluorescent wheel 103. The reflected fluorescence is converged and collimated by the focusing and collimating lens group 105, and thus large-angle beams with a Lambertian body (which refers to that the radiation brightness of a radiation source in all directions keeps unchanged and the change of the radiation intensity over an angle between the observation direction and the normal of the surface light source obey Cosine Law) distribution are compressed into approximately parallel beams, which are then emitted to the dichroic mirror 104. The dichroic mirror 104 reflects the fluorescence to a light stick. In addition, the blue laser beams are transmitted to the dichroic mirror 104 via a “blue laser beam loop” after passing through the aforementioned transmission region, pass through the dichroic mirror, and finally enter the light stick.

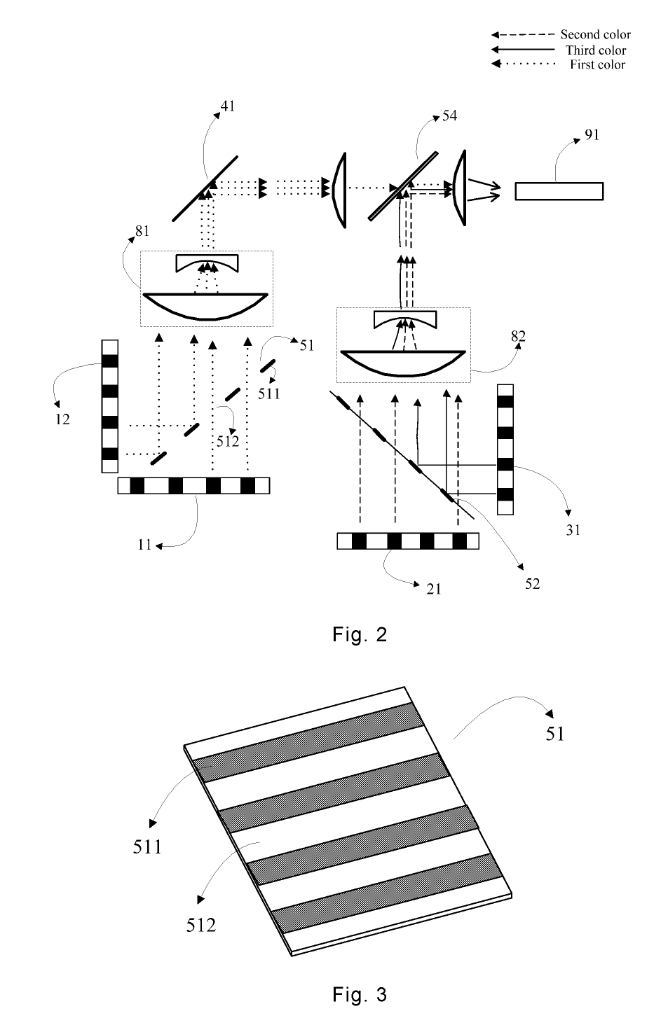

Some embodiments of the present disclosure provide a laser projection apparatus. As shown in FIG. 2, the laser projection apparatus includes a first laser array 11, a second laser array 12, a third laser array 21, a fourth laser array 31, a first light-combining component 51, a second light-combining component 52 and a beam-combining component 54. The first laser array 11 is configured to emit first laser beams of a first color. The second laser array 12 is configured to emit second laser beams of the first color. The third laser array 21 is configured to emit third laser beams of a second color. The fourth laser array 31 is configured to emit fourth laser beams of a third color. The first light-combining component 51 is configured to make the first laser beams and the second laser beams advance along a first direction. The second light-combining component 52 is configured to make the third laser beams and the fourth laser beams advance along a second direction. The beam-combining component 54 is located on an optical path of the first laser beams and the second laser beams emitted from the first light-combining component 51, and is located on an optical path of the third laser beams and the fourth laser beams emitted from the second light-combining component 52. The beam-combining component 54 is configured to make the first laser beams and the second laser beams emitted from the first light-combining component 51, and the third laser beams and the fourth laser beams emitted from the second light-combining component 52 advance along a third direction. The first color, the second color and the third color are different from each other, and each of the first color, the second color and the third color is one of red, green and blue.

In the laser projection apparatus of the embodiments of the present disclosure, two laser arrays for emitting the laser beams of the first color and one light-combining component for combining the laser beams are provided. In addition, the third laser array for emitting the third laser beams of the second color, the fourth laser array for emitting the fourth laser beams of the third color, and one light-combining component for combining the third laser beams and the fourth laser beams are provided. Since a plurality of laser arrays are used, a projection brightness of the laser projection apparatus is improved. Furthermore, since laser beams emitted by the plurality of laser arrays are combined by the light-combining components, a volume of the laser projection apparatus is smaller.

In some embodiments, the first direction is the same as the second direction, and is different from the third direction. In some other embodiments, the first direction is different from the second direction, and is the same as the third direction. In some other embodiments, the first direction, the second direction and the third direction are all different from each other. The first direction, the second direction, and the third direction can also have other relationships thereamong, which are not limited herein.

In some embodiments, the first color is green, the second color is red, and the third color is blue.

The laser projection apparatus is illustrated below by taking the laser projection apparatus including the first light-combining component 51 and the second light-combining component 52 as an example.

In some embodiments, as shown in FIG. 2, the first laser array 11 and the second laser array 12 are arranged perpendicular to each other. That is, a plane in which first lasers of the first laser array 11 are arranged and a plane in which second lasers of the second laser array 12 are arranged are arranged perpendicular to each other. In addition, the first light-combining component 51 is configured to transmit the first laser beams and reflect the second laser beams. In this way, more first and second lasers are arranged in a limited space, and thus the power of the laser beams of the first color is increased.

It will be noted that, in order to combine the first laser beams and the second laser beams, the first light-combining component 51 is inclined relative to the first laser array 11 and the second laser array 12, that is, a surface of the first light-combining component 51 adjacent to the first laser array 11 is inclined relative to the plane in which the lasers of the first laser array 11 are arranged. The angle of inclination of the first light-combining component 51 relative to the first laser array 11 is not specially limited, as long as the first light-combining component 51 can transmit the first laser beams and reflect the second laser beams. In some embodiments, an angle between the first light-combining component 51 and the first laser array 11 ranges from 30° to 65°. That is, an angle between the surface of the first light-combining component 51 adjacent to the first laser array 11 and the plane in which the first lasers of the first laser array 11 ranges from 30° to 65°. The angle is for example 30°, 40°, 45°, 55°, or 65°. In some embodiments, the angle between the first light-combining component 51 and the first laser array 11 ranges from 40° to 50°. The angle is for example 40°, 43°, 47°, or 50°.

In some embodiments, the first laser array 11 is arranged non-perpendicular to the second laser array 12, that is, the plane in which the first lasers of the first laser array 11 are arranged is non-perpendicular to the plane in which the second lasers of the second laser array 12 are arranged. For example, an angle between the two planes is 110° or 80°. At this time, only the angle between the first light-combining component 51 and the first laser array 11 may need to be adjusted to cooperatively perform the transmission of the first laser beams and the reflection of the second laser beams.

In some embodiments, as shown in FIG. 3, the first light-combining component 51 includes a plurality of first reflection parts 511 and a plurality of first transmission parts 512. The plurality of first reflection parts 511 are located on outgoing optical paths of the second laser beams, and are configured to reflect the second laser beams. The plurality of first transmission parts 512 are located on outgoing optical paths of the first laser beams, and are configured to transmit the first laser beams. In some embodiments, the plurality of first reflection parts 511 and the plurality of first transmission parts 512 are alternately arranged. The number of the plurality of first reflection parts 511 is not limited, and is determined according to the number of and the arrangement way of the second lasers in the second laser array 12. The number of the plurality of first transmission parts 512 is not limited, and is determined according to the number of and the arrangement way of the first lasers in the first laser array 11.

In some embodiments, the first light-combining component 51 includes a single first reflection part 511 and a single first transmission part 512. The first reflection part 511 is configured to reflect the second laser beams, and the first transmission part 512 is configured to transmit the first laser beams.

In some embodiments, as shown in FIG. 3, the first light-combining component 51 includes a glass substrate and one or more strips of reflective films that are plated at interval on a surface of the glass substrate away from the first laser array 11. The first reflection part 511 corresponds to a portion of the first light-combining component 51 having the strip of reflective film. In some examples, the first transmission part 512 corresponds to a portion of the first light-combining component 51 that does not have the strip of reflective film, and is configured to transmit laser beams with various colors. In some other embodiments, the portion of the first light-combining component 51 that does not have the strip of reflective film is removed or has an opening, and the first transmission part 512 corresponds to a hollow portion of the first light-combining component 51. In some other examples, the first light-combining component 51 includes a non-transparent substrate and one or more strips of reflective films that are plated at interval on a surface of the non-transparent substrate, and the portion of the first light-combining component 51 that does not have the strip of reflective film is removed or has an opening. The first reflection part 511 corresponds to the portion of the first light-combining component 51 having the strip of reflective film. The first transmission part 512 corresponds to a hollow portion of the first light-combining component 51.

In some embodiments, polarization directions of the first laser beams are perpendicular to polarization directions of the second laser beams, and the first light-combining component 51 is a dichroic element. The dichroic element transmits the first laser beams and reflects the second laser beams due to the difference between polarization directions of the first laser beams and the second laser beams.

In some embodiments, as shown in FIG. 2, the third laser array 21 and the fourth laser array 31 are arranged perpendicular to each other, that is, a plane in which third lasers of the third laser array 21 are arranged and a plane in which fourth lasers of the fourth laser array 31 are arranged are arranged perpendicular to each other. The second light-combining component 52 is inclined relative to the third laser array 21, and combines the third laser beams and the fourth laser beams. With this arrangement, an optical path of a laser beam of a fourth color needs not to be separately provided, thereby saving a space occupied by the optical path of the laser beam of the fourth color, and further reducing the volume of the laser projection apparatus.

It will be noted that, in order to combine the third laser beams and the fourth laser beams, the second light-combining component 52 is inclined relative to the third laser array 21 and the fourth laser array 31, that is, a surface of the second light-combining component 52 adjacent to the third laser array 21 is inclined relative to the plane in which the lasers of the third laser array 21 are arranged. The angle of inclination of the second light-combining component 52 relative to the third laser array 21 is not specially limited, as long as the second light-combining component 52 can transmit the third laser beams and reflect the fourth laser beams. In some embodiments, an angle between the second light-combining component 52 and the third laser array 21 ranges from 30° to 65°. That is, an angle between the surface of the second light-combining component 52 adjacent to the third laser array 21 and the plane in which the third lasers of the third laser array 21 are arranged ranges from 30° to 65°. The angle is for example 30°, 40°, 45°, 55°, or 65°. In some embodiments, the angle between the second light-combining component 52 and the third laser array 21 ranges from 40° to 50°. The angle is for example 40°, 43°, 47°, or 50°.

In some embodiments, the third laser array 21 is arranged non-perpendicular to the fourth laser array 31. That is, the plane in which the third lasers of the third laser array 21 are arranged is non-perpendicular to the plane in which the fourth lasers of the fourth laser array 31 are arranged. For example, an angle between the two planes is 110° or 80°. At this time, only the angle between the second light-combining component 52 and the third laser array 21 may need to be adjusted so as to cooperatively perform the transmission of the third laser beams and the reflection of the fourth laser beams.

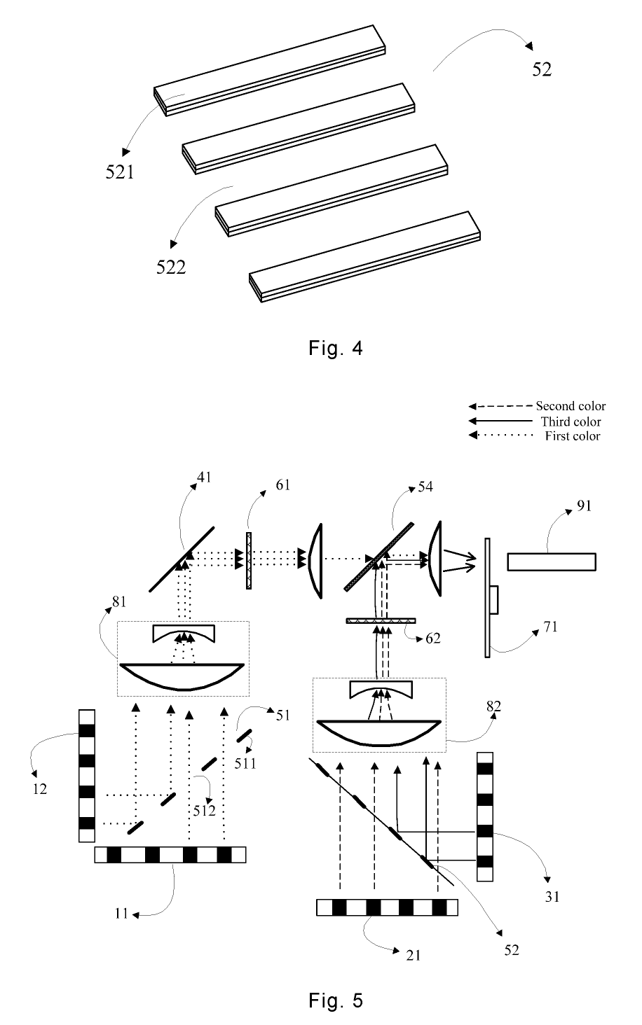

In some embodiments, as shown in FIG. 4, the second light-combining component 52 includes a plurality of second reflection parts 521 and a plurality of second transmission parts 522. The plurality of second reflection parts 521 are located on outgoing optical paths of the fourth laser beams, and are configured to reflect the fourth laser beams. The plurality of the second transmission parts 522 are located on the outgoing optical paths of the third laser beams, and are configured to transmit the third laser beams. In some embodiments, the plurality of second reflection parts 521 and the plurality of second transmission parts 522 are alternately arranged. The number of the plurality of second reflection parts 521 is not limited, and is determined according to the number of and the arrangement way of the fourth lasers in the fourth laser array 31. The number of the plurality of second transmission parts 522 is not limited, and is determined according to the number of and the arrangement way of the third lasers in the third laser array 21.

In some embodiments, the second light-combining component 52 includes a single second reflection part 521 and a single second transmission part 522. The second reflection part 521 is configured to reflect the fourth laser beams, and the second transmission part 522 is configured to transmit the third laser beams.

In some embodiments, the second light-combining component 52 includes a glass substrate and one or more strips of reflective films that are plated at interval on a surface of the glass substrate away from the third laser array 21. The second reflection part 521 corresponds to a portion of the second light-combining component 52 having the strip of reflective film. In some examples, the second transmission part 522 corresponds to a portion of the second light-combining component 52 that does not have the strip of reflective film, and is configured to transmit laser beams with various colors. In some other embodiments, the portion of the second light-combining component 52 that does not have the strip of reflective film is removed or has an opening, and the second transmission part 522 corresponds to a hollow portion of the second light-combining component 52. In some other examples, as shown in FIG. 4, the second light-combining component 52 includes a non-transparent substrate and one or more strips of reflective films that are plated at interval on a surface of the non-transparent substrate, and the portion of the second light-combining component 52 that does not have the strip of reflective film is removed or has an opening. The second reflection part 521 corresponds to the portion of the second light-combining component 52 having the strip of reflective film. The second transmission part 522 corresponds to a hollow portion of the second light-combining component 52.

In some embodiments, the second light-combining component 52 is a dichroic element, and is configured to transmit the third laser beams and reflect the second laser beams by using the principle that the wavelengths of the third laser beams and the fourth laser beams are different.

In some embodiments, a power P1 of the fourth laser array 31 ranges from 50 W to 85 W. A power P2 of the third laser array 21 ranges from 45 W to 75 W. A sum P3 of a power of the first laser array 11 and a power of the second laser array 12 ranges from 25 W to 50 W. In some examples, the power of the first laser array 11 is equal to the power of the second laser array 12. In some other embodiments, the difference between the power of the first laser array 11 and the power of the second laser array 12 does not exceed 10 W.

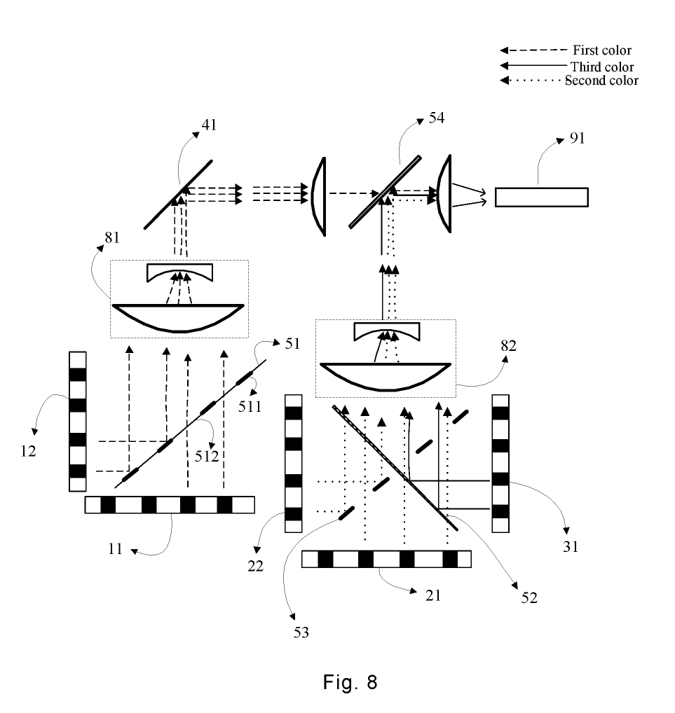

In some embodiments, as shown in FIG. 8, the laser projection apparatus includes the first laser array 11, the second laser array 12, the third laser array 21, the fourth laser array 31, a fifth laser array 22, the first light-combining component 51, the second light-combining component 52, a third light-combining component 53 and the beam-combining component 54. The first laser array 11 is configured to emit the first laser beams of the first color, the second laser array 12 is configured to emit the second laser beams of the first color, the third laser array 21 is configured to emit the third laser beams of the second color, the fourth laser array 31 is configured to emit the fourth laser beams of the third color, and the fifth laser array 22 is configured to emit fifth laser beams of the second color. The first light-combining component 51 is configured to make the first laser beams and the second laser beams advance along the first direction. The third light-combining component 53 is configured to, together with the second light-combining component 52, make the third laser beams, the fourth laser beams and the fifth laser beams advance along the second direction. The beam-combining component 54 is located on an optical path of the first laser beams and the second laser beams emitted from the first light-combining component 51, and is located on an optical path of the third laser beams, the fourth laser beams and the fifth laser beams emitted from the second light-combining component 52 and the third light-combining component 53. The beam-combining component 54 is configured to make the first laser beams, the second laser beams that are emitted from the first light-combining component 51, and the third laser beams, the fourth laser beams and the fifth laser beams that are emitted from the second light-combining component 52 and the third light-combining component 53 advance along a third direction.

In the laser projection apparatus provided by the embodiments of the present disclosure, two laser arrays for emitting the laser beams of the first color and one light-combining component for combining the laser beams are provided. In addition, one fourth laser array, two laser arrays for emitting the laser beams of the second color, and two light-combining components for combining the laser beams are provided. Since a plurality of laser arrays are used, the projection brightness of the laser projection apparatus is improved. Furthermore, since laser beams emitted by the plurality of laser arrays are combined by the light-combining components, the volume of the laser projection apparatus is smaller.

The arrangements of the first direction, the second direction and the third direction refer to the aforementioned description, which will not be repeated here.

In some embodiments, the first color is red, the second color is green, and the third color is blue. In some other embodiments, the first color is green, the second color is red, and the third color is blue.

The laser projection apparatus is illustrated below by taking the laser projection apparatus including the first light-combining component 51, the second light-combining component 52 and the third light-combining component 53 as an example.

The structures and arrangements of the first laser array 11, the second laser array 12 and the first light-combining component 51 please refer to the aforementioned related description, which will not be repeated here.

In some embodiments, as shown in FIG. 8, the third laser array 21 and the fourth laser array 31 are arranged perpendicular to each other, the third laser array 21 and the fifth laser array 22 are arranged perpendicular to each other, and the fourth laser array 31 and the fifth laser array 22 are arranged opposite to each other. The second light-combining component 52 and the third light-combining component 53 are arranged in an X type. For example, the second light-combining component 52 and the third light-combining component 53 are located across each other between the fourth laser array 31 and the fifth laser array 22. The second light-combining component 52 is configured to transmit the third laser beams and the fifth laser beams, and reflect the fourth laser beams. The third light-combining component 53 is configured to transmit the third laser beams and the fourth laser beams, and reflect the fifth laser beams.

In some embodiments, the second light-combining component 52 is perpendicular to the third light-combining component 53. In some other embodiments, the second light-combining component 52 is non-perpendicular to the third light-combining component 53. The third laser beams, the fourth laser beams and the fifth laser beams are combined by the second light-combining component 52 and the third light-combining component 53, and thus more lasers for emitting the laser beams of the second color are arranged in the limited space to increase the power of the laser beams of the second color. Meanwhile, the laser beams of the second color and the laser beams of the third color are combined, and thus the optical path of a laser beam of the third color needs not to be separately provided, so that a space occupied by the optical path of the laser beam of the third color is saved, and the volume of the laser projection apparatus is further reduced.

It will be noted that, in order to combine the third laser beams, the fourth laser beams and the fifth laser beams, the second light-combining component 52 and the third light-combining component 53 are inclined relative to the fourth laser array 31, that is, surfaces of the second light-combining component 52 and the third light-combining component 53 adjacent to the fourth laser array 31 are inclined relative to a plane in which the fourth lasers of the fourth laser array 31 are arranged. Angles of inclination of the second light-combining component 52 and the third light-combining component 53 relative to the fourth laser array 31 is not specially limited, as long as the second light-combining component 52 can transmit the third laser beams and the fifth laser beams and reflect the fourth laser beams, and the third light-combining component 53 can transmit the third laser beams and the fourth laser beams and reflect the fifth laser beams. In some embodiments, an angle between the second light-combining component 52 and the fourth laser array 31 ranges from 30° to 65°. That is, an angle between the surface of the second light-combining component 52 adjacent to the fourth laser array 31 and the plane in which the fourth lasers of the fourth laser array 31 are arranged ranges from 30° to 65°. The angle is for example 30°, 40°, 45°, 55°, or 65°. In some embodiments, the angle between the surface and the plane ranges from 40° to 50°. The angle is for example 40°, 43°, 47°, or 50°. In some embodiments, the angle between the third light-combining component 53 and the fifth laser array 22 ranges from 30° to 65°. That is, the angle between the surface of the third light-combining component 53 adjacent to the fifth laser array 22 and the plane in which the fifth lasers of the fifth laser array 22 are arranged ranges from 30° to 65°. The angle is for example 30°, 40°, 45°, 55°, or 65°. In some embodiments, the angle between third light-combining component 53 and the fifth laser array 22 ranges from 40° to 50°. The angle is for example 40°, 43°, 47°, or 50°.

In some embodiments, the angles between the third laser array 21 and the fourth laser array 31 and between the third laser array 21 and the fifth laser array 22 are not 90°. For example, the angles are 110° or 80°. At this time, only the angle between the second light-combining component 52 and the third laser array 21 may need to be adjusted to cooperatively perform the transmission of the third laser beams and the fifth laser beams and the reflection of the fourth laser beams, and the angle between the third light-combining component 53 and the fifth laser array 22 needs to be adjusted to cooperatively perform the transmission of the third laser beams and the fourth laser beams and the reflection of the fifth laser beams.

The structure and material of the second light-combining component 52 please refer to the aforementioned related contents, which will not be repeated here.

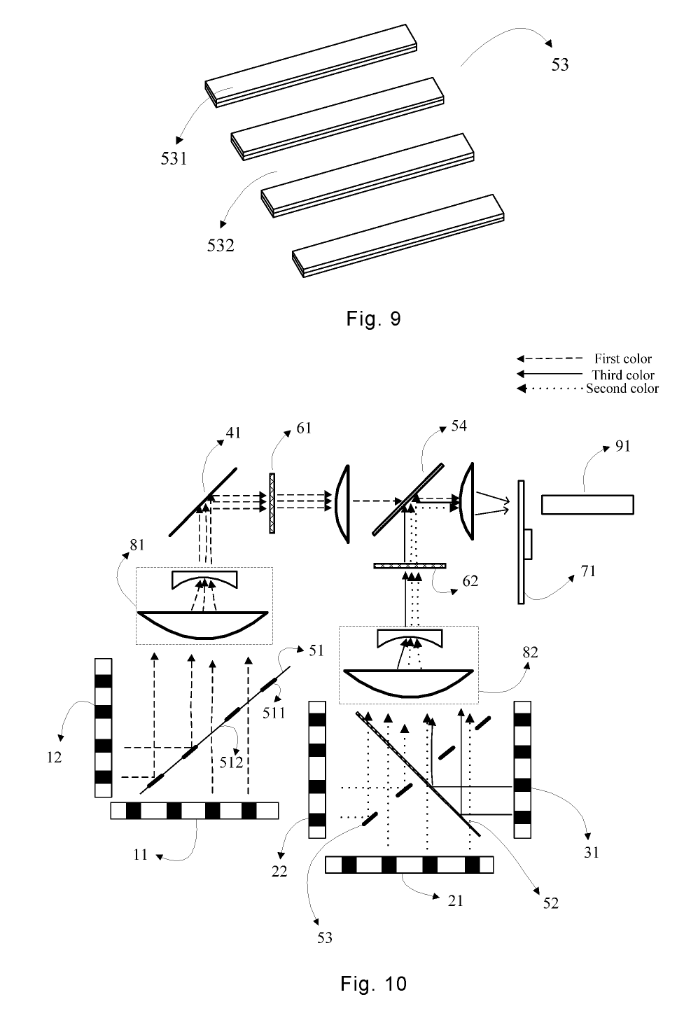

In some embodiments, as shown in FIG. 9, the third light-combining component 53 includes a plurality of third reflection parts 531 and a plurality of third transmission parts 532. The plurality of third reflection parts 531 are located on outgoing optical paths of the fifth laser beams, and are configured to reflect the fifth laser beams. The plurality of third transmission parts 532 are located on outgoing optical paths of the third laser beams, and are configured to transmit the third laser beams and the fourth laser beams which have been reflected by the second light-combining component 52. In some embodiments, the plurality of third reflection parts 531 and the plurality of third transmission parts 532 are alternately arranged. The number of the plurality of third reflection parts 531 is not limited, and is determined according to the number of and the arrangement way of the fifth lasers in the fifth laser array 22. The number of the plurality of third transmission parts 532 is not limited, and is determined according to the number of and the arrangement way of the third lasers in the third laser array 21 and the fourth lasers in the fourth laser array 31.

In some embodiments, the third light-combining component 53 includes a single third reflection part 531 and a single third transmission part 532. The third reflection part 531 is configured to reflect the fifth laser beams. The third transmission part 532 is configured to transmit the third laser beams and the fourth laser beams which have been reflected by the second light-combining component 52.

In some embodiments, the third light-combining component 53 includes a glass substrate and one or more strips of reflective films that are plated at interval on a surface of the glass substrate away from the third laser array 21. The third reflection part 531 corresponds to a portion of the third light-combining component 53 having the strip of reflective film. In some embodiments, the third transmission part 532 corresponds to a portion of the third light-combining component 53 that does not have the strip of reflective film, and is configured to transmit beams with various colors. In some other embodiments, the portion of the third light-combining component 53 that does not have the strip of reflective film is removed or has an opening, and the third transmission part 532 corresponds to a hollow portion of the third light-combining component 53. In some other embodiments, as shown in FIG. 9, the third light-combining component 53 includes an non-transparent substrate and one or more strips of reflective films that are plated at interval on the non-transparent substrate, and the portion of the third light-combining component 53 that does not have the strip of reflective film is removed or has an opening. The third reflection part 531 corresponds to a portion of the third light-combining component 53 having the strip of reflective film. The third transmission part 532 corresponds to a hollow portion of the third light-combining component 53.

In some embodiments, the second light-combining component 52 is assembled with the third light-combining component 53 by passing the second light-combining component 52 through the hollow portion provided in a central area of the third light-combining component 53. In some embodiments, the second light-combining component 52 includes two portions with the same size. The third light-combining component 53 is sandwiched between the two portions so that the third-combing component and the two portions are assembled together.

In some embodiments, a power P1 of the fourth laser array 31 ranges from 50 W to 85 W. A sum P2 of a power of the first laser array 11 and a power of the second laser array 12 ranges from 65 W to 95 W. In some embodiments, the power of the first laser array 11 is equal to the power of the second laser array 12. In some other embodiments, the difference between the power of the first laser array 11 and the power of the second laser array 12 does not exceed 15 W. A sum P3 of a power of the third laser array 21 and a power of the fifth laser array 22 ranges from 25 W to 55 W. In some embodiments, the power of the third laser array 21 is equal to the power of the fifth laser array 22. In some other embodiments, the difference between the power of the third laser array 21 and the power of the fifth laser array 22 does not exceed 10 W.

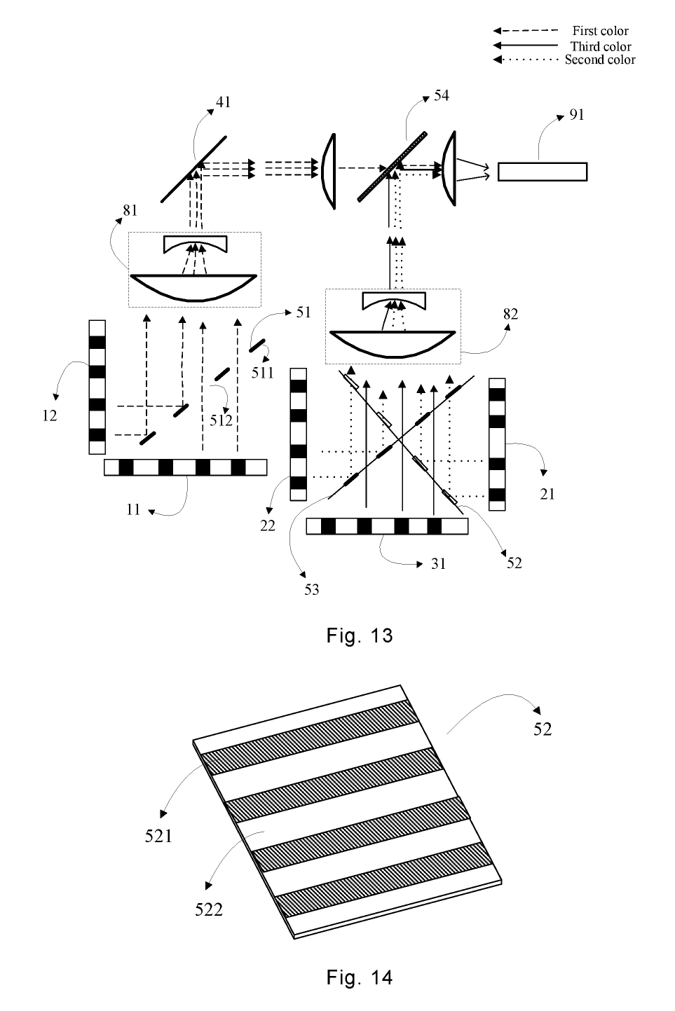

In some embodiments, as shown in FIG. 13, the laser projection apparatus includes a first laser array 11, a second laser array 12, a third laser array 21, a fourth laser array 31, a fifth laser array 22, a first light-combining component 51, a second light-combining component 52, a third light-combining component 53 and a beam-combining component 54. The first laser array 11 is configured to emit first laser beams of a first color, the second laser array 12 is configured to emit second laser beams of the first color, the third laser array 21 is configured to emit third laser beams of a second color, the fourth laser array 31 is configured to emit fourth laser beams of a third color, and the fifth laser array 22 is configured to emit fifth laser beams of the second color. The first light-combining component 51 is configured to make the first laser beams and the second laser beams advance along a first direction. The third light-combining component 53 is configured to, together with the second light-combining component 52, make the third laser beams, the fourth laser beams and the fifth laser beams advance along the second direction. The beam-combining component 54 is located on an optical path of the first laser beams and the second laser beams which are emitted from the first light-combining component 51, and is located on an optical path of the third laser beams, the fourth laser beams and the fifth laser beams which are emitted from the second light-combining component 52 and the third light-combining component 53. The beam-combining component 54 is configured to make the first laser beams and the second laser beams which are emitted from the first light-combining component 51, and the third laser beams, the fourth laser beams and the fifth laser beams which are emitted from the second light-combining component 52 and the third light-combining component 53 advance along the third direction.

In the laser projection apparatus provided by the embodiments of the present disclosure, two laser arrays for emitting the laser beams of the first color and one light-combining component for combining the laser beams are provided. In addition, the fourth laser array, two laser arrays which emit the laser beams of the second color and two light-combining components for combining the laser beams are provided. Since a plurality of laser arrays are used, the projection brightness of the laser projection apparatus is improved. Furthermore, since the laser beams emitted from the plurality of laser arrays are combined by the light-combining components, the volume of the laser projection apparatus is smaller.

The arrangements of the first direction, the second direction and the third direction refer to the aforementioned description, which will not be repeated here.

In some embodiments, the first color is red, the second color is green, and the third color is blue. In some embodiments, polarization directions of the third laser beams and the fifth laser beams are perpendicular to each other.

The laser projection apparatus is illustrated below by taking the laser projection apparatus including the first light-combining component 51, the second light-combining component 52 and the third light-combining component 53 as an example.

The structures and arrangements of the first laser array 11, the second laser array 12 and the first light combining component 51 please refer to the aforementioned related description, which will not be repeated here.

In some embodiments, as shown in FIG. 13, the third laser array 21 and the fourth laser array 31 are arranged perpendicular to each other, the fifth laser array 22 and the fourth laser array 31 are arranged perpendicular to each other, and the third laser array 21 and the fifth laser array 22 are arranged opposite to each other. The second light-combining component 52 and the third light-combining component 53 are arranged in an X type. For example, the second light-combining component 52 and the third light-combining component 53 are located across each other between the third laser array 21 and the fifth laser array 22. The second light-combining component 52 is configured to transmit the fourth laser beams and the fifth laser beams, and reflect the third laser beams. The third light-combining component 53 is configured to transmit the third laser beams and the fourth laser beams, and reflect the fifth laser beams.

In some embodiments, the second light-combining component 52 is perpendicular to the third light-combining component 53. In some other embodiments, the second light-combining component 52 is non-perpendicular to the third light-combining component 53. The third laser beams, the fourth laser beams and the fifth laser beams are combined by the second light-combining component 52 and the third light-combining component 53, and thus more lasers for emitting the laser beams of the second color are arranged in the limited space to increase the power of the laser beams of the second color. Meanwhile, the laser beams of the second color and the laser beams of the third color are combined, and the optical path of a laser beam of the third color needs not to be separately provided, so that the space occupied by the optical path of the laser beam of the third color is saved, and the volume of the laser projection apparatus is further reduced.

It will be noted that, in order to combine the third laser beams, the fourth laser beams and the fifth laser beams, the second light-combining component 52 and the third light-combining component 53 are inclined relative to the fourth laser array 31, that is, surfaces of the second light-combining component 52 and the third light-combining component 53 adjacent to the fourth laser array 31 are inclined relative to a plane in which the fourth lasers of the fourth laser array 31 are arranged. The angles of inclination of the second light-combining component 52 and the third light-combining component 53 relative to the fourth laser array 31 are not specially limited, as long as the second light-combining component 52 can transmit the fourth laser beams and the fifth laser beams and reflect the third laser beams, and the third light-combining component 53 can transmit the third laser beams and the fourth laser beams and reflect the fifth laser beams. In some embodiments, an angle between the second light-combining component 52 and the third laser array 21 ranges from 30° to 65°. That is, an angle between the surface of the second light-combining component 52 adjacent to the third laser array 21 and the plane in which the third lasers of the third laser array 21 are arranged ranges from 30° to 65°. The angle is for example 30°, 40°, 45°, 55°, or 65°. In some embodiments, the angle between the second light-combining component 52 and the third laser array 21 ranges from 40° to 50°. The angle is for example 40°, 43°, 47°, or 50°. In some embodiments, the angle between the third light-combining component 53 and the third laser array 21 ranges from 30° to 65°. That is, the angle between the surface of the third light-combining component 53 adjacent to the third laser array 21 and the plane in which the third lasers of the third laser array 21 are arranged ranges from 30° to 65°. The angle is for example 30°, 40°, 45°, 55°, or 65°. In some embodiments, the angle between the third light-combining component 53 and the third laser array 21 ranges from 40° to 50°. The angle is for example 40°, 43°, 47°, or 50°.

In some embodiments, the angles between the third laser array 21 and the fourth laser array 31, and between the fourth laser array 31 and the fifth laser array 22 are not 90°. For example, the angle is 110° or 80°. At this time, only the angle between the second light-combining component 52 and the third laser array 21 may need to be adjusted to cooperatively perform the transmissions of the fourth laser beams and the fifth laser beams and the reflection of the third laser beams, and the angle between the third light-combining component 53 and the third laser array 21 needs to be adjusted to cooperatively perform the transmissions of the third laser beams and the fourth laser beams and the reflection of the fifth laser beams.

In some embodiments, as shown in FIG. 14, the second light-combining component 52 includes a plurality of second reflection parts 521 and a plurality of second transmission parts 522. The plurality of second reflection parts 521 are located on outgoing optical paths of the third laser beams, and are configured to reflect the third laser beams. The plurality of second reflection parts 521 are also at least partially located on outgoing optical paths of the fifth laser beams which has been reflected by the third light-combining component 53, and are configured to transmit the fifth laser beams. The plurality of second transmission parts 522 are located on outgoing optical paths of the fourth laser beams, and are configured to transmit the fourth laser beams. In some embodiments, the plurality of second reflection parts 521 and the plurality of second transmission parts 522 are alternately arranged. The number of the plurality of second reflection parts 521 and the number of the plurality of second transmission parts 522 are not limited, and are determined according to the number of and the arrangement way of the lasers in the third laser array 21, the fourth laser array 31 and the fifth laser array 22.

In some embodiments, the second light-combining component 52 includes a single second reflection part 521 and a single second transmission part 522. The second reflection part 521 is configured to reflect the third laser beams. The second transmission part 522 is configured to transmit the fourth laser beams and the fifth laser beams.

In some embodiments, the third laser beams are S-polarized laser beams, the fifth laser beams are P-polarized laser beams, and polarization directions of the S-polarized laser beams are perpendicular to polarization directions of the P-polarized laser beams. In some embodiments, as shown in FIG. 14, the second light-combining component 52 includes the glass substrate and stripes of first polarizing films located at interval on a surface of the glass substrate away from the fourth laser array 31. The first polarizing films are configured to reflect the S-polarized laser beams (the third laser beams) and transmit the P-polarized laser beams (the fifth laser beams). The second reflection part 521 corresponds to a portion of the second light-combining component 52 having the first polarizing film. In some embodiments, the second transmission part 522 corresponds to a portion of the second light-combining component 52 that does not have the first polarizing films, and is configured to transmit beams with various colors. In some other embodiments, the portion of the second light-combining component 52 that does not have the first polarizing film is removed or has an opening, and the second transmission part 522 corresponds to a hollow portion of the second light-combining component 52.

In some embodiments, as shown in 15, the third light-combining component 53 includes a plurality of third reflection parts 531 and a plurality of third transmission parts 532. The plurality of third reflection parts 531 are located on outgoing optical paths of the fifth laser beams, and are configured to reflect the fifth laser beams. The plurality of third reflection parts are also at least partially located on the outgoing optical paths of the third laser beams which has been reflected by the second light-combining component 52, and are configured to transmit the third laser beams. The plurality of third transmission parts 532 are located on outgoing optical paths of the fourth laser beams, and are configured to transmit the fourth laser beams. In some embodiments, the plurality of third reflection parts 531 and the plurality of third transmission parts 532 are alternately arranged. The number of the plurality of third reflection parts 531 and the number of the third transmission parts 532 are determined according to the number and arrangement ways of the fourth laser array 31, the third laser array 21 and the fifth laser array 22.

In some embodiments, the third light-combining component 53 includes a single third reflection part 531 and a single third transmission part 532. The third reflection part 531 is configured to reflect the fifth laser beams. The third transmission part 532 is configured to transmit the third laser beams and the fourth laser beams.

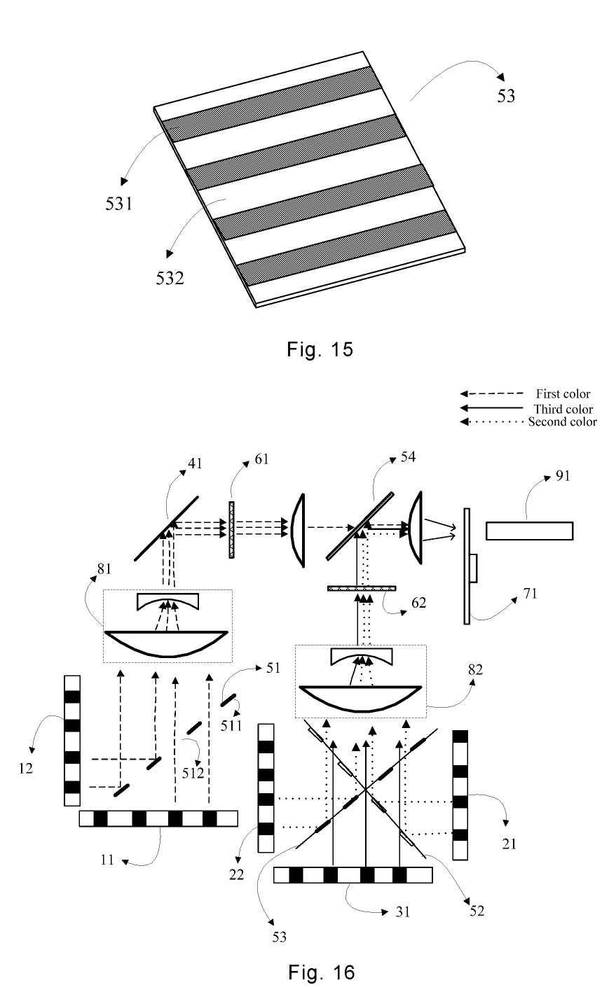

In some embodiments, the third laser beams are S-polarized laser beams, the fifth laser beams are P-polarized laser beams, and polarization directions of the S-polarized laser beams are perpendicular to polarization directions of the P-polarized laser beams. In some embodiments, as shown in FIG. 15, the third light-combining component 53 includes the glass substrate and stripes of second polarizing films located at interval on a surface of the glass substrate away from the fourth laser array 31. The second polarizing films are configured to reflect the P-polarized laser beams (the fifth laser beams) and transmit the S-polarized laser beams (the third laser beams). The third reflection part 531 corresponds to a portion of the third light-combining component 53 having the second polarizing film. In some embodiments, the third transmission part 532 corresponds to a portion of the third light-combining component 53 that does not have the second polarizing film, and is configured to transmit beams with various colors. In some other embodiments, the portion of the third light-combining component 53 that does not have the second polarizing film is removed or has an opening, and the third transmission part 532 corresponds to a hollow portion of the third light-combining component 53.

In some embodiments, the second light-combining component 52 is assembled with the third light-combining component 53 by passing the second light-combining component 52 through the hollow portion in a central area of the third light-combining component 53. In some embodiments, the second light-combining component 52 includes two portions with the same size. The third light-combining component 53 is sandwiched between the two portions so that the third light-combining component 53 and the two portions are assembled together.

In some embodiments, a power P1 of the fourth laser array 31 ranges from 50 W to 85 W. A sum P2 of a power of the first laser array 11 and a power of the second laser array 12 ranges from 65 W to 95 W. In some embodiments, the power of the first laser array 11 is equal to the power of the second laser array 12. In some other embodiments, a difference between the power of the first laser array 11 and the power of the second laser array 12 does not exceed 15 W. A sum P3 of a power of the third laser array 21 and a power of the fifth laser array 22 ranges from 25 W to 55 W. In some embodiments, the power of the third laser array 21 is equal to the power of the fifth laser array 22. In some other embodiments, a difference between the power of the third laser array 21 and the power of the fifth laser array 22 does not exceed 10 W.

In some embodiments, as shown in FIG. 16, the second light-combining component 52 includes a plurality of second reflection parts 521 and a plurality of second transmission parts 522. The plurality of second reflection parts 521 are located on outgoing optical paths of the third laser beams, and are configured to reflect the third laser beams. The plurality of second transmission parts 522 are located on outgoing optical paths of the fourth laser beams, and are configured to transmit the fourth laser beams. The plurality of second transmission parts 522 are also at least partially located on outgoing optical paths of the fifth laser beams which have been reflected by the third light-combining component 53, and are configured to transmit the fifth laser beams.

The structure of the second light-combining component 52 is, for example, the structure of the second light-combining component 52 described with reference to FIG. 4, the structure of the second light-combining component 52 described with reference to FIG. 14, or the aforementioned other structures of the second light-combining component 52, which will not be repeated here.

In some embodiments, as shown in 16, the third light-combining component 53 includes a plurality of third reflection parts 531 and a plurality of third transmission parts 532. The plurality of third reflection parts 531 are located on outgoing optical paths of the fifth laser beams, and are configured to reflect the fifth laser beams. The plurality of third transmission parts 532 are located on outgoing optical paths of the fourth laser beams, and are configured to transmit the fourth laser beams. The plurality of third transmission parts 532 are also at least partially located on outgoing optical paths of the third laser beams which have been reflected by the second light-combining component 52, and are configured to transmit the third laser beams.

The structure of the third light-combining component 53 is, for example, the structure of the third light-combining component 53 described with reference to FIG. 9, the structure of the third light-combining component 53 described with reference to FIG. 15, or the aforementioned other structures of the third light-combining component 53, which will not be repeated here.

In some embodiments, as shown in FIG. 2, FIG. 8 and FIG. 13, the laser projection apparatus further includes a light homogenizing component 91, and the light homogenizing component 91 is configured to receive laser beams emitted from the beam-combining component 54.

In some embodiments, as shown in FIG. 2, FIG. 8 and FIG. 13, the laser projection apparatus further includes a reflection element 41 located between the first light-combining component 51 and the beam-combining component 54. The reflection element 41 is configured to reflect the first laser beams and the second laser beams emitted from the first light-combining component 51 so as to turn the first laser beams and the second laser beams emitted from the first light-combining component 51 a preset angle θ, where 60°≤θ≤125°. For example, θ is 65°, 70°, 80°, 95°, 100°, 110°, or 120°. In some embodiments, θ is 90°, that is, an angle between the reflection element 41 and a principal optic axis of the first and second laser beams emitted from the first light-combining component 51 is 45°. Due to the deflection of the reflection element 41, the optical path distance of the first laser beams and the second laser beams in a horizontal direction in FIG. 2 is greatly shortened, facilitating the reduction of the volume of the laser projection apparatus.

In some embodiments, the reflection element 41 is a plane mirror. In some embodiments, an angle between the plane mirror and the principal optic axis of the first and second laser beams emitted from the first light-combining component 51 is a, where 25≤α≤65°. For example, α is 30°, 40°, 45°, 55°, or 60°. In this way, the first laser beams and the second laser beams emitted from the first light-combining component 51 are turned by the plane mirror, and then enter the beam-combining component 54.

In some embodiments, an angle between the beam-combining component 54 and a principal optic axis of laser beams emitted from the second light-combining component 52 is β, where 25°≤β≤65°. For example, β is 30°, 40°, 45°, 55°, or 60°. In this way, the beam-combining component 54 transmits the first laser beams and the second laser beams emitted from the first light-combining component 51, and reflects the third laser beams and the fourth laser beams emitted from the second light-combining component 52. Therefore, the beam-combining component 54 not only combines the laser beams of three colors, but also turns the optical paths of the third laser beams and the fourth laser beams, so that the volume of the laser projection apparatus is reduced. In some embodiments, β=45°.

In some embodiments, the beam-combining component 54 deflects the optical paths of the first laser beams and the second laser beams. At this time, the first laser beams and the second laser beams emitted from the first light-combining component 51 reach the beam-combining component 54, and then are reflected to the light homogenizing component 91. Meanwhile, the laser beams emitted from the second light-combining component 52 reach the beams-combining element 54, and then is transmitted to the light homogenizing component 91. Under this case, the reflection element 41 is located between the second light-combining component 52 and the beam-combining element 54, and is configured to turn the optical paths of the third laser beams and the fourth laser beams.

In some embodiments, the beams-combining element 54 transmits the first laser beams and the second laser beams. At this time, the first laser beams and the second laser beams emitted from the first light-combining component 51 reach reflection element 41, are reflected to the beam-combining component 54 by the reflection element 41, and pass through the beams combining component 54. Meanwhile, the laser beams emitted from the second light-combining component 52 reach the beams-combining element 54, and then is reflected to the beams homogenizing component 91.

In some embodiments, as shown in FIG. 2, FIG. 8 and FIG. 13, the laser projection apparatus further includes a first beams-shrinking lens group 81 located on the optical paths of the first laser beams and the second laser beams emitted from the first light-combining component 51, and the first beams-shrinking lens group 81 is configured to shrink the first laser beams and the second laser beams to reduce an area of a speckle, so that transmission efficiencies of the first laser beams and the second laser beams are increased. In some embodiments, the laser projection apparatus further includes a second beams-shrinking lens group 82 located on outgoing optical paths of the second light-combining component 52/the second light-combining component 52 and the third light-combining component 53, and the second beams-shrinking lens group 82 is configured to shrink the laser beams emitted from the light-combining component. In this way, not only the transmission efficiencies of the beams are increased, but also the diffusion efficiencies of the beams are increased due to the reduction of the area of the speckle illuminated by each beam to a diffusion component.

In some embodiments, as shown in FIG. 5, FIG. 10 and FIG. 16, the laser projection apparatus further includes a scattering wheel 71. The scattering wheel 71 is located on the optical path of the laser beams emitted from the beam-combining component 54, and is controlled by a motor to rotate. In some embodiments, a material of a wheel of the scattering wheel 71 is a diffusion sheet material. In some other embodiments, the wheel of the scattering wheel 71 includes a transparent glass, and microstructures located on a surface of the transparent glass, or a diffuser coated on a surface of the transparent glass. In this way, the laser beams are dynamically diffused by the diffusion sheet while they pass through the diffusion sheet, thereby some spatially random phases are generated for the laser beams, so that the speckle effect caused by the high coherence of the laser beams during imaging is reduced, and the projection imaging quality is improved.

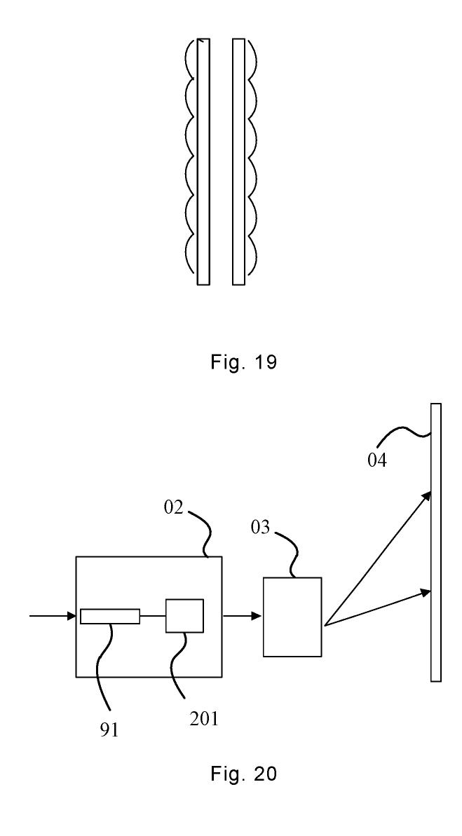

In some embodiments, as shown in FIGS. 5, 10 and 16, the laser projection apparatus further includes a first diffusion component 61 and a second diffusion component 62. The first diffusion component 61 is fixedly located on the outgoing optical path of the first light-combining component 51, and is configured to statically diffuse the first laser beams and the second laser beams. The second diffusion component 62 is fixedly located on the outgoing optical path of the second light-combining component 52, and is configured to statically diffuse the laser beams emitted from the second light-combining component 52. The first diffusion component 61 uses, for example, the diffusion sheet material or a fly-eye lens (as shown in FIG. 19). The second diffusion component 62 uses, for example, the diffusion sheet material or the fly-eye lens (as shown in FIG. 19). The first laser beams, the second laser beams and the laser beams which are emitted from the second light-combining component 52 respectively pass through the first diffusion component 61 and the second diffusion component 62 that are fixedly located, and the spatial phases of the beams with various colors are increased, thereby a condition of constant phase, which causes an interference, is destroyed in a certain extent. In addition, by cooperatively using the first diffusion component 61, the second diffusion component 62 that are fixed and the movable scattering wheel 71, the effects of static diffusion and dynamic diffusion are superimposed, and divergence angles of the beams are diversified. However, since the difference of optical distances of the beams are diversified due to the diversification of the divergence angles and the optical distance determines the change of the phase, the phases of the beams change, so that a probability that generates the random phase is increased due to the difference of the optical distances. The random phase can generate a random speckle pattern, and when the random speckle pattern produces an integral effect on the human eye, the phenomenon of light and dark speckle is weaker, so that a speckle effect of the laser beams is reduced effectively, and the display quality of the projection imaging is improved.

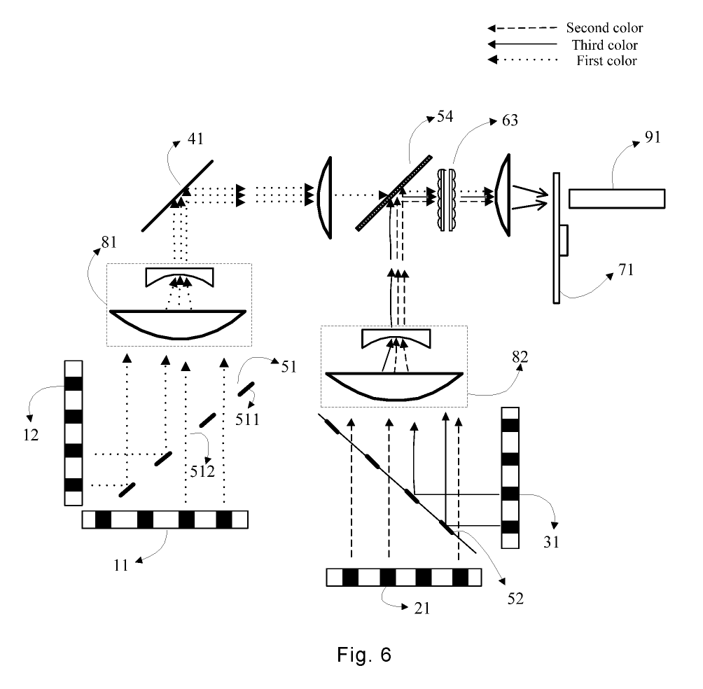

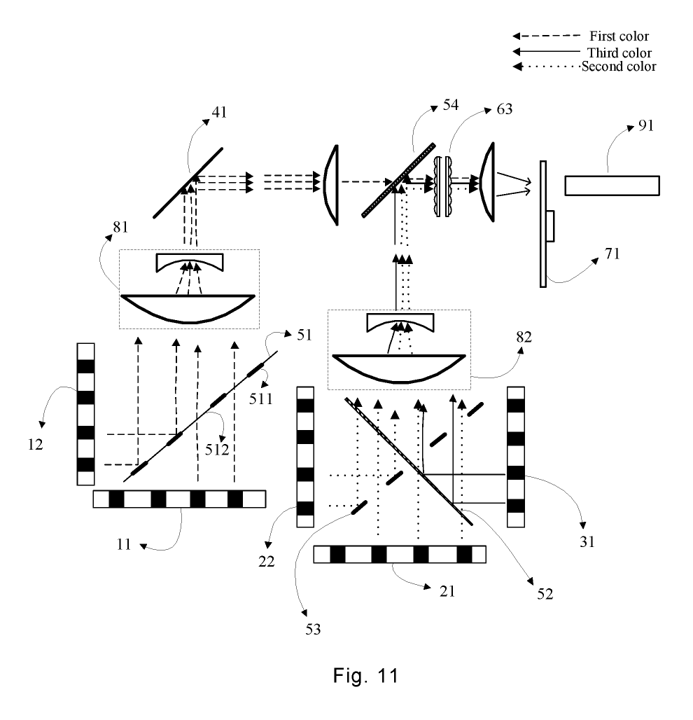

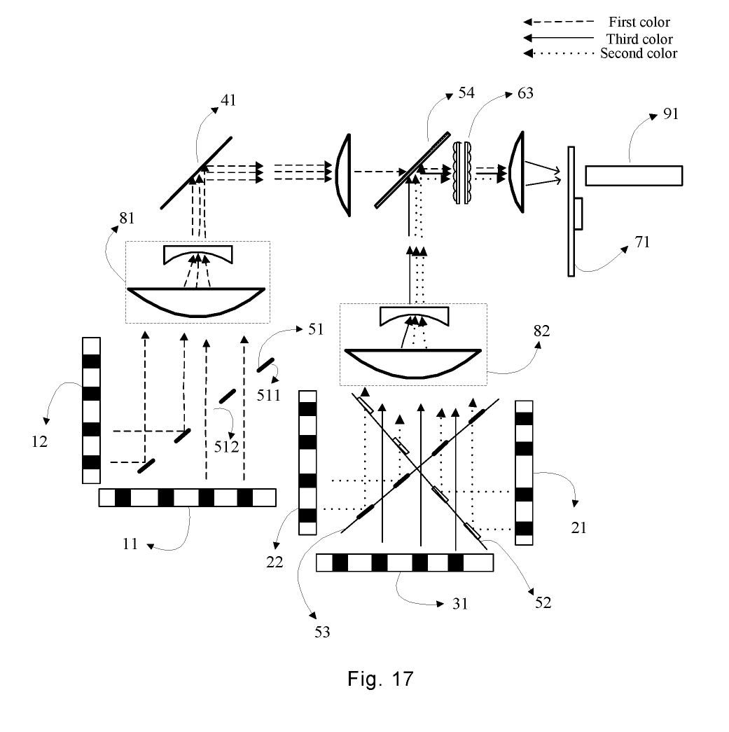

In some embodiments, as shown in FIG. 6, FIG. 11 and FIG. 17, the laser projection apparatus further includes a scattering wheel 71 and a third diffusion component 63. The third diffusion component 63 is fixedly located on the outgoing optical path of the beam-combining component 54, and statically diffuses the laser beams emitted from the beam-combining component 54. The third diffusion component 63 uses, for example, the diffusion sheet material or a fly-eye lens. The scattering wheel 71 is also located on the outgoing optical path of the beam-combining component 54, and is configured to dynamically diffuse the laser beams emitted from the beam-combining component 54. For example, the scattering wheel 71 is located on the outgoing optical path of the third diffusion component 63, or is located on an opposite side of the third diffusion component 63 away from the outgoing optical path. The third diffusion component 63 increases the spatial phase of the beams with various colors, and destroys the condition of constant phase, which causes interference, in a certain extent. In addition, the rotating scattering wheel 71 itself can generate some spatial random phase for the laser beams compared to the fixed third diffusion component 63 itself, and thus the coherence of the laser beams is better destroyed. Therefore, by cooperatively using the third diffusion component 63 and the movable scattering wheel 71, the effects of static diffusion and dynamic diffusion are superimposed, and divergence angle of the beams are diversified. However, since the difference of optical distances of the beams is diversified due to the diversification of the divergence angle and the optical distance determines the change of the phase, the phases of the beams change, so that a probability that generates the random phase is increased due to the difference of the optical distance. The random phase enable to generate a random speckle pattern, and when the random speckle pattern produces an integral effect on the human eye, the phenomenon of light and dark speckle is weaker, so that a speckle effect of the laser beams is reduced effectively, and the display quality of the projection imaging is improved.

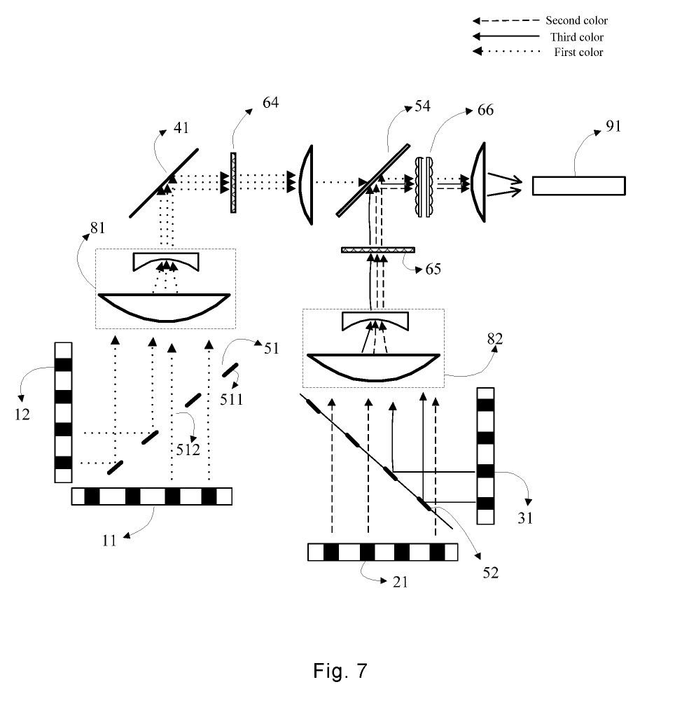

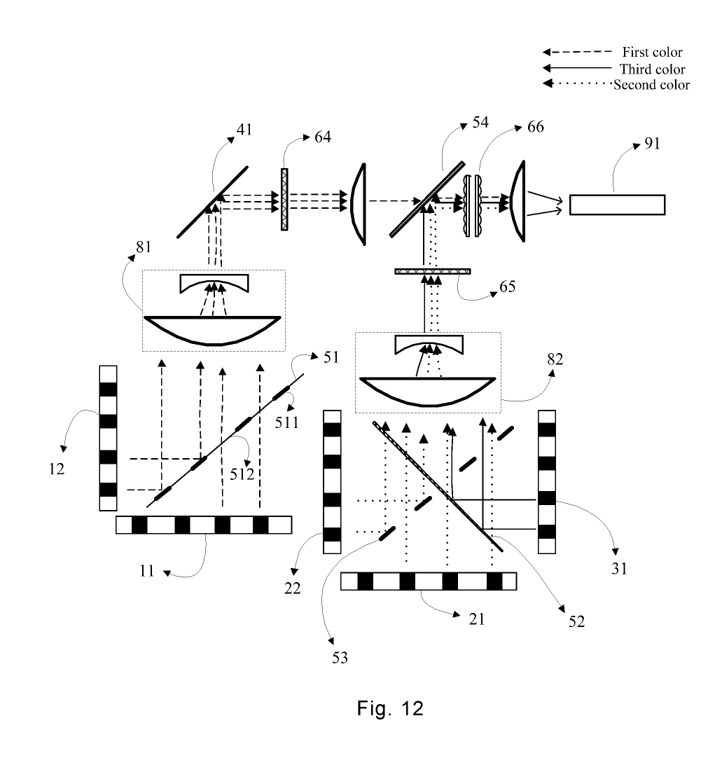

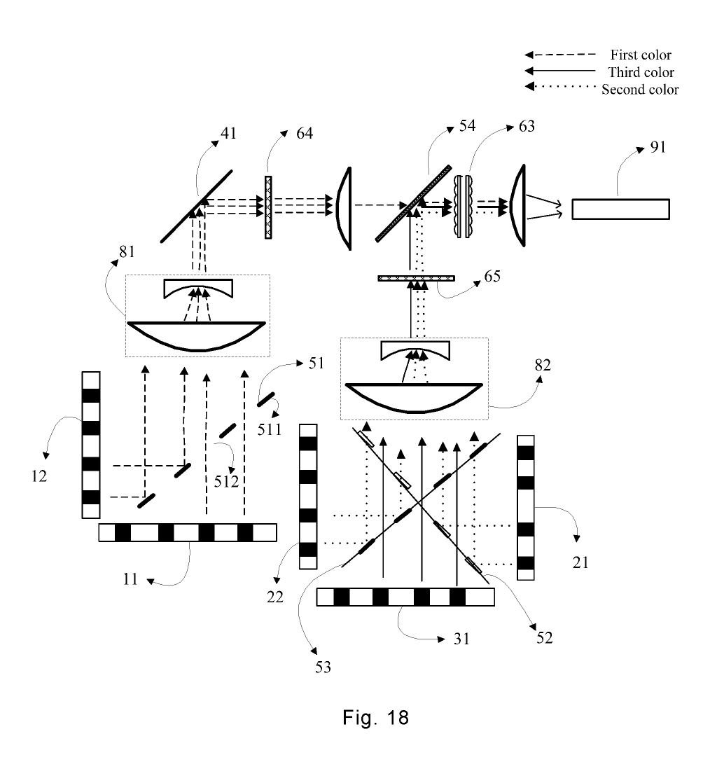

In some embodiments, as shown in FIGS. 7, 12 and 18, the laser projection apparatus includes a first diffusion component 61, a second diffusion component 62 and a third diffusion component 63. The positions of the first diffusion component 61, the second diffusion component 62 and the third diffusion component 63 please refer to the aforementioned related contents, which will not be repeated here. The first diffusion component 61 and the second diffusion component 62 use, for example, a diffusion material, or a fly -eye lens, which is not be limited. The first laser beams, the second laser beams, the third laser beams and the fourth laser beams respectively pass through the first diffusion component 61 and the second diffusion component 62 that are fixedly located, and the spatial phases thereof are all increased, thereby the condition of constant phase, which causes the interference, is destroyed in a certain extent. Next, a third diffusion component 63 located on the outgoing optical path of the beam-combining component 54 diffuses the combined beams again, the random phase is further increased, so that the coherence of the laser beams emitted from the beams combining component 54 is better destroyed. In some embodiments, the third diffusion component 63 uses the fly-eye lens (as shown in FIG. 19). Because the fly-eye lens has high beam transmittance and has a better homogenization and diffusion effect to the beams, when used in combination with the first diffusion component 61 and the second diffusion component 62, not only the speckle effect of the laser beam is effectively weakened, but also the energy of the beams is homogenized. Therefore, the use of a diffusion device that generates mechanical rotation is avoided, and the volume of the laser projection apparatus is further reduced.

In some embodiments, as shown in FIG. 20, the laser projection apparatus further includes an optical machine 02 and a lens 03. The optical machine 02 is located on the outgoing optical path of the beam-combining component 54. The optical machine 02 includes a beam homogenizing component 91 and a light valve element 201. The beam homogenizing component 91 is configured to homogenize the laser beams emitted from the beam-combining component 54, and transmits the homogeneous laser beams to the light valve element 201. The light valve element 201 is configured to modulate the homogeneous laser beams, and emits the modulated laser beams to the lens 03. The lens 03 is configured to image the modulated laser beams and project the image onto a screen 04 or any other displayable medium.

It will be apparent to those skilled in the art that various modifications and variations can be made for the present disclosure without departing from the spirit and scope of the disclosure. In this way, if these modifications and variations of the present disclosure fall in the scope of the claims of the present disclosure and their equivalent technologies, the present disclosure is also intended to include these modifications and variations.

What is claimed is:

1. A laser projection apparatus, comprising:
a first laser array configured to emit first laser beams of a first color;
a second laser array configured to emit second laser beams of the first color;
a third laser array configured to emit third laser beams of a second color;
a fourth laser array configured to emit fourth laser beams of a third color;
a first light-combining component configured to make the first laser beams and the second laser beams advance along a first direction;
a second light-combining component configured to make the third laser beams and the fourth laser beams advance along a second direction; and
a beam-combining component located on an optical path of the first laser beams and the second laser beams emitted from the first light-combining component and an optical path of the third laser beams and the fourth laser beams emitted from the second light-combining component, wherein the beam-combining component is configured to make the first laser beams and the second laser emitted from the first light-combining component, and the third laser beams and the fourth laser beams emitted from the second light-combining component advance along a third direction, wherein
the first color, the second color and the third color are different from each other, and each of the first color, the second color and the third color is one of a red, green and blue color.

2. The laser projection apparatus according to claim 1, wherein the first color is a green color, the second color is a red color, and the third color is a blue color.

3. The laser projection apparatus according to claim 2, further comprising:
a reflection element located on an optical path between the first light-combining component and the beam-combining component, and configured to reflect the first laser beams and the second beams emitted from the first light-combining component to turn the first laser beams and the second laser beams emitted from the first light-combining component a preset angle θ, where 60°≤θ≤125°.

4. The laser projection apparatus according to claim 2, wherein the first laser array and the second laser array are arranged perpendicular to each other, and the first light-combining component is configured to transmit the first laser beams and reflect the second laser beams.

5. The laser projection apparatus according to claim 4, wherein the first light-combining component is a dichroic element, and polarization directions of the first laser beams is perpendicular to polarization directions of the second laser beams, or
the first light-combining component comprises a plurality of first transmission parts and a plurality of first reflection parts, the plurality of first transmission parts and the plurality of first reflection parts are alternately arranged, the plurality of first transmission parts are configured to transmit the first laser beams, and the plurality of first reflection parts are configured to reflect the second laser beams, or
the first light-combining component comprises a single first transmission part and a single first reflection part, the first transmission part is configured to transmit the first laser beams, and the first reflection part is configured to reflect the second laser beams.

6. The laser projection apparatus according to claim 1, wherein the third laser array and the fourth laser array are arranged perpendicular to each other, and the second light-combining component is configured to transmit the third laser beams and reflect the fourth laser beams.

7. The laser projection apparatus according to claim 6, wherein the second light-combining component is a dichroic element, or
the second light-combining component comprises a plurality of second transmission parts and a plurality of second reflection parts, the plurality of second transmission parts and the plurality of second reflection parts are alternately arranged, the plurality of second transmission parts are configured to transmit the third laser beams, the plurality of second reflection parts are configured to reflect the fourth laser beams, or
the second light-combining component comprises a single second transmission part and a single second reflection part, the second transmission part is configured to transmit the third laser beams, and the second reflection part is configured to reflect the fourth laser beams.

8. The laser projection apparatus according to claim 6, wherein
a sum of a power of the first laser array and a power of the second laser array is in a range from 25 W to 50 W,
a power of the third laser array is in a range from 45 W to 75 W, and
a power of the fourth laser array is in a range from 50 W to 85 W.

9. The laser projection apparatus according to claim 2, wherein
an angle between the first light-combining component and the first laser array ranges from 30° to 65°, and
an angle between the second light-combining component and the fourth laser array ranges from 30° to 65°.

10. The laser projection apparatus according to claim 1, further comprising:
a fifth laser array configured to emit fifth laser beams of the second color; and
a third light-combining component configured to, together with the second light-combining component, make the third laser beams, the fourth laser beams and the fifth laser beams advance along the second direction.

11. The laser projection apparatus according to claim 10, wherein
the first laser array and the second laser array are arranged perpendicular to each other,
the third laser array and the fourth laser array are arranged perpendicular to each other,
the third laser array and the fifth laser array are arranged perpendicular to each other,
the fourth laser array and the fifth laser array are arranged opposite to each other,
the first light-combining component is configured to transmit the first laser beams, and reflect the second laser beams,
the second light-combining component and the third light-combining component are arranged in an X type,
the second light-combining component is configured to transmit the third laser beams and the fifth laser beams, and reflect the fourth laser beams, and
the third light-combining component is configured to transmit the third laser beams and the fourth laser beams, and reflect the fifth laser beams.

12. The laser projection apparatus according to claim 11, wherein the first light-combining component comprises a plurality of first transmission parts and a plurality of first reflection parts, and the plurality of first transmission parts and the plurality of first reflection parts are alternately arranged;
the second light-combining component is a dichroic element, or the second light-combining component comprises a plurality of second transmission parts and a plurality of second reflection parts, and the plurality of second transmission parts and the plurality of second reflection parts are alternately arranged;
the third light-combining component comprises a plurality of third transmission parts and a plurality of third reflection parts, and the plurality of third transmission parts and the plurality of third reflection parts are alternately arranged.

13. The laser projection apparatus according to claim 11, wherein
a sum of a power of the first laser array and a power of the second laser array is in a range from 65 W to 95 W,
a sum of a power of the third laser array and a power of the fifth laser array is in a range from 25 W to 50 W, and
a power of the fourth laser array is in a range from 50 W to 85 W.

14. The laser projection apparatus according to claim 10, wherein polarization directions of the third laser beams and the fifth laser beams are perpendicular to each other.

15. The laser projection apparatus according to claim 14, wherein
the first laser array and the second laser array are arranged perpendicular to each other,
the third laser array and the fourth laser array are arranged perpendicular to each other,
the fifth laser array and the fourth laser array are arranged perpendicular to each other,
the fifth laser array and the third laser array are arranged opposite to each other,
the first light-combining component is configured to transmit the first laser beams and reflect the second laser beams,
the second light-combining component and the third light-combining component are arranged in an X type,
the second light-combining component is configured to transmit the fourth laser beams and the fifth laser beams, and reflect the third laser beams, and
the third light-combining component is configured to transmit the third laser beams and the fourth laser beams, and reflect the fifth laser beams.

16. The laser projection apparatus according to claim 15, wherein the first light-combining component comprises a plurality of first transmission parts and a plurality of first reflection parts, and the plurality of first transmission parts and the plurality of first reflection parts are alternately arranged;
the second light-combining component comprises a plurality of second transmission parts and a plurality of second reflection parts, and the plurality of second transmission parts and the plurality of second reflection parts are alternately arranged; and
the third light-combining component comprises a plurality of third transmission parts and a plurality of third reflection parts, and the plurality of third transmission parts and the plurality of third reflection parts are alternately arranged.

17. The laser projection apparatus according to claim 10, wherein a sum of a power of the first laser array and a power of the second laser array is in a range from 65 W to 95 W, a sum of a power of the third laser array and a power of the fifth laser array is in a range from 25 W to 50 W, and a power of the fourth laser array is in a range from 50 W to 85 W.

18. The laser projection apparatus according to claim 10, wherein
an angle between the first light-combining component and the first laser array ranges from 30° to 65°,
an angle between the second light-combining component and the fourth laser array ranges from 30° to 65°, and
an angle between the third light-combining component and the fifth laser array ranges from 30° to 65°.

19. The laser projection apparatus according to claim 1, further comprising a scattering wheel located on an outgoing optical path of the beam-combining component, and configured to be controlled to rotate to scatter beams emitted from the beam-combining component.

20. The laser projection apparatus according to claim 19, further comprising:
a first diffusion component fixedly located on an outgoing optical path of the first light-combining component, and configured to statically diffuse the first laser beams and the second laser beams;
a second diffusion component fixedly located on an outgoing optical path of the second light-combining component, and configured to statically diffuse the third laser beams and the fourth laser beams; and
a third diffusion component fixedly located on an outgoing optical path of the beam-combining component, and configured to statically diffuse first laser beams, second laser beams, third laser beams and fourth laser beams emitted from the beam-combining component.
